(19) United States
(12) Patent Application Publication
(10) Pub. No.: US 2016/0303606 A1
(43) Pub. Date: Oct. 20, 2016

(54) EXHAUST PLENUM AND CABINET ASSEMBLY FOR PRODUCTION COATER

(71) Applicant: THOMAS ENGINEERING, INC., Hoffman Estates, IL (US)

(72) Inventors: Timothy C. PILIPAUSKAS, Arlington Heights, IL (US); Jose M. ANGEL, Hanover Park, IL (US)

(21) Appl. No.: 15/096,719

(22) Filed: Apr. 12, 2016

Related U.S. Application Data
(60) Provisional application No. 62/148,602, filed on Apr. 16, 2015.

(51) Int. Cl. B05B 15/12; A61J 3/00; B05B 9/00

(52) U.S. Cl. CPC B05B 15/1222; B05B 9/00; A61J 3/005

(57) ABSTRACT

A production coater for coating a material with a solution or a suspension. The production coater including a cabinet with an integrated exhaust plenum providing an exhaust flow path from a coating drum to an output of the production coater. The production coater and the integrated exhaust path provides a system for coating materials with a solution that includes a reduced number of parts, simplified cleaning, service and maintenance, and does not require the lifting of heavy parts as is required of previously known production coaters.

### CROSS REFERENCE TO RELATED APPLICATION

This Application claims the benefit of U.S. Provisional Patent Application Ser. No. 62/148,602, filed on 16 Apr. 2015. The co-pending U.S. Provisional Patent Application is hereby incorporated by reference herein in its entirety and is made a part hereof, including but not limited to those portions which specifically appear hereinafter.

### BACKGROUND OF THE INVENTION

1. Field of the Invention

This invention relates to an exhaust plenum and cabinet assembly for a production coater for coating a material to be coated with a solution or a suspension. This invention includes an exhaust plenum integrated with a cabinet to provide an air flow path for exhaust from a drum in the production coater.

2. Discussion of Related Art

Fully-perforated side-vented coating pans and coaters have been in use since the early 70's. In the past, such coaters for coating pharmaceuticals and other substrates were expensive, complex, difficult to clean and included a multiplicity of parts. The apparatus of the prior art are inherently expensive, inflexible, difficult to operate properly, difficult to clean and sized to a specific application. Traditional coaters include a separate exhaust plenum that can be inserted into a production coater, providing an exhaust path. FIG. 1 shows an example of such a known exhaust plenum. Known exhaust plenums are also described in the production coater described U.S. patent application Ser. No. 14/198,703 and the production coater with exchangeable drums described in U.S. patent application Ser. No. 12/493,710. U.S. patent application Ser. Nos. 14/198,703 and 12/493,710 are hereby incorporated by reference in their entirety. These known exhaust plenums generally require a large number of parts, can be difficult to service, maintain and clean. As such, there is a need for an exhaust plenum with: fewer parts; simple servicing, maintenance and cleaning; and does not require an operator to lift heavy parts.

### SUMMARY OF THE INVENTION

A production coater of this invention is a machine for coating a material with a solution or suspension. The production coater preferably includes a cabinet housing an internal coating drum that is rotated by a motor to coat cores or other materials with the solution or suspension, for example, but not limited to, coating pills or tablets. The production coater of this invention preferably includes an integrated exhaust plenum formed by a plurality of plenum walls and a surface of the cabinet housing. The plenum walls and the cabinet housing provide an exhaust path from the drum to an outlet of the cabinet housing. This integrated design of exhaust plenum reduces the number of parts, simplifies service and maintenance, does not require the lifting of heavy parts, and is easily cleanable when compared to known production coaters.

In an embodiment of this invention, the production coater includes the cabinet forming an outer housing for the production coater. The cabinet encloses the coating drum positioned within the cabinet. The drum is preferably releaseably connectable to a motor that rotates the drum. The coating drum also preferably includes a baffle and/or a divider in an interior of the coating drum to improve the design of the drum to agitate cores, solutions and/or suspensions within the drum to ensure adequate coverage of the cores.

In a preferred embodiment of this invention, the production coater includes an exhaust plenum with a plurality of walls. The exhaust plenum is integrally formed with an interior surface of the cabinet to form an enclosed pathway with an inlet and an outlet. The inlet opening of the exhaust plenum is in air-flow communication with an opening in the coating drum. The enclosed pathway allows air and exhaust to be vented from an interior of the drum and exhausted from the production coater through the outlet.

### BRIEF DESCRIPTION OF THE DRAWINGS

These and other objects and features of this invention will be better understood from the following detailed description taken in conjunction with the following generalized and simplified drawings, wherein:

FIG. 1 is a perspective view of a prior art exhaust plenum assembly for use with a separate coater cabinet.

FIG. 2 shows a production coater according to an embodiment of this invention.

FIG. 3 show the production coater of FIG. 2 with an access door open to show an interior of the production coater.

FIG. 4 is a cross-sectional view of the production coater of FIG. 2 showing an air-flow path through the production coater.

FIG. 5 is a perspective view of the production coater of FIG. 2 with a cabinet housing removed to show an exhaust plenum and a drum of an embodiment of this invention.

FIG. 6 is a pair of assembly drawings of a rear plate installation for the exhaust plenum shown in FIG. 5.

FIG. 7 is a pair of assembly drawings of a front plate installation for the exhaust plenum shown in FIG. 5.

FIG. 8 is a set of drawings showing rotation of a lower flap of the exhaust plenum shown in FIG. 5.

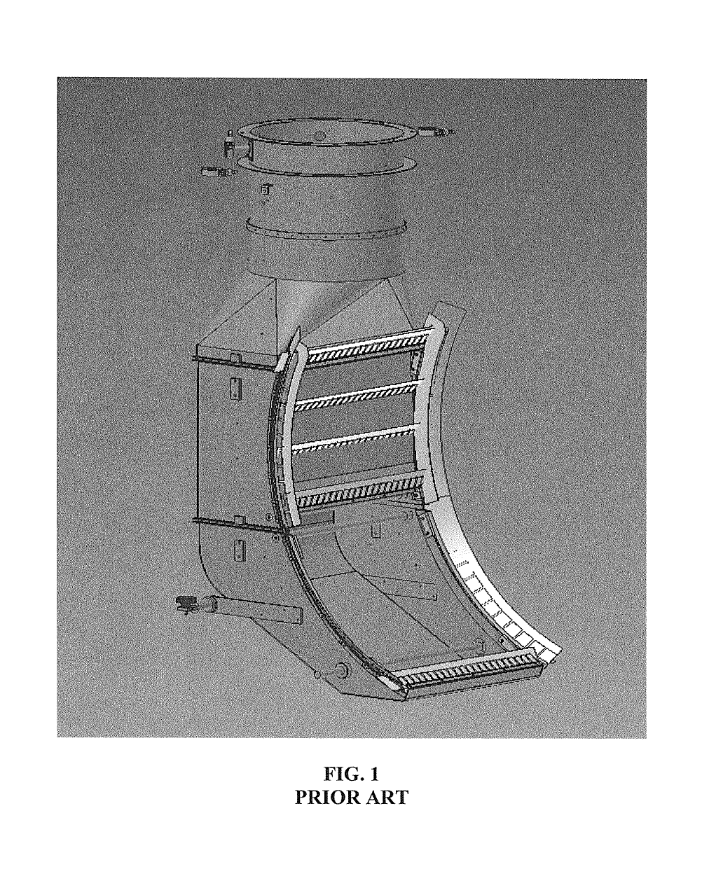

### DETAILED DESCRIPTION OF THE INVENTION

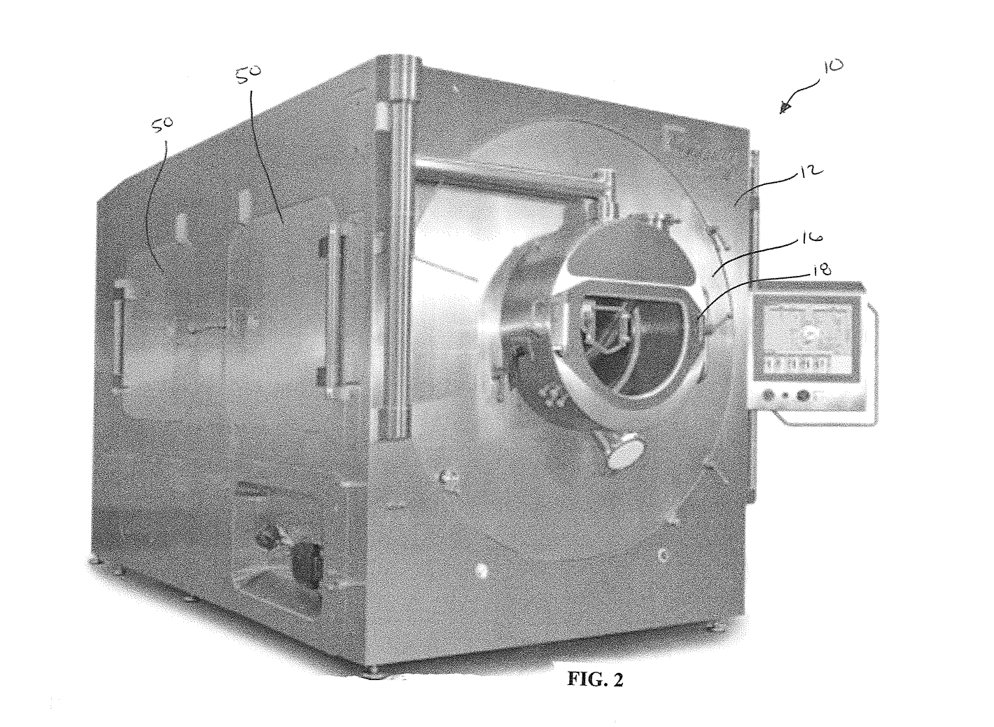

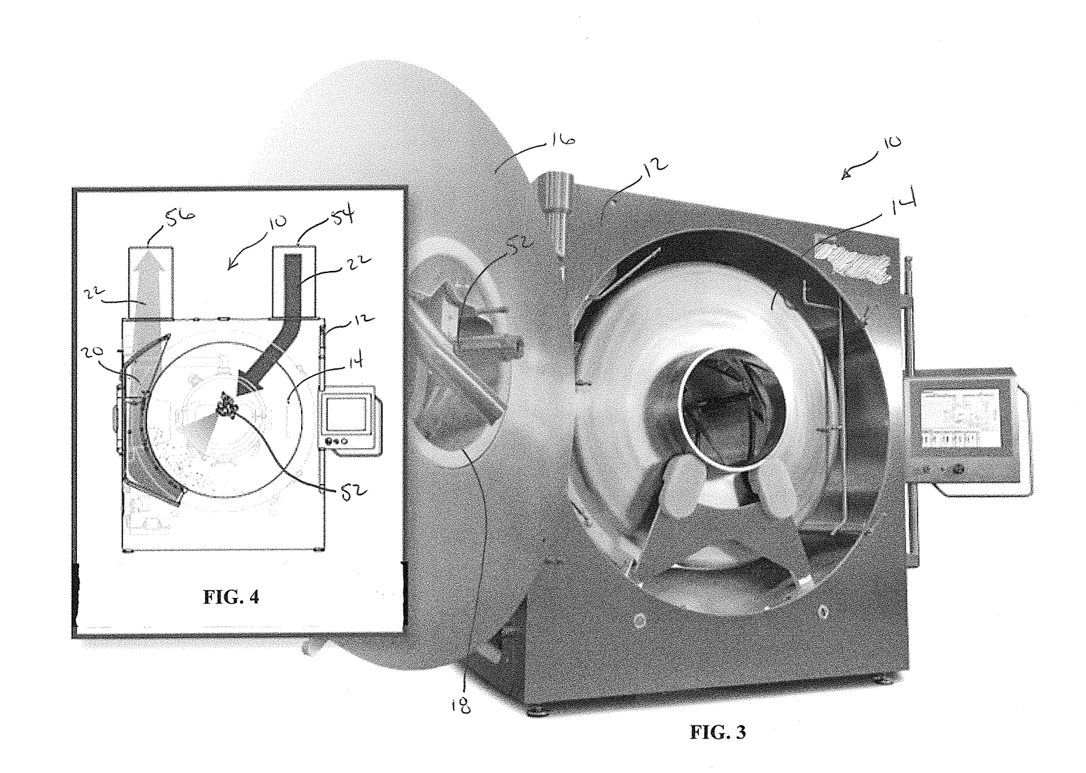

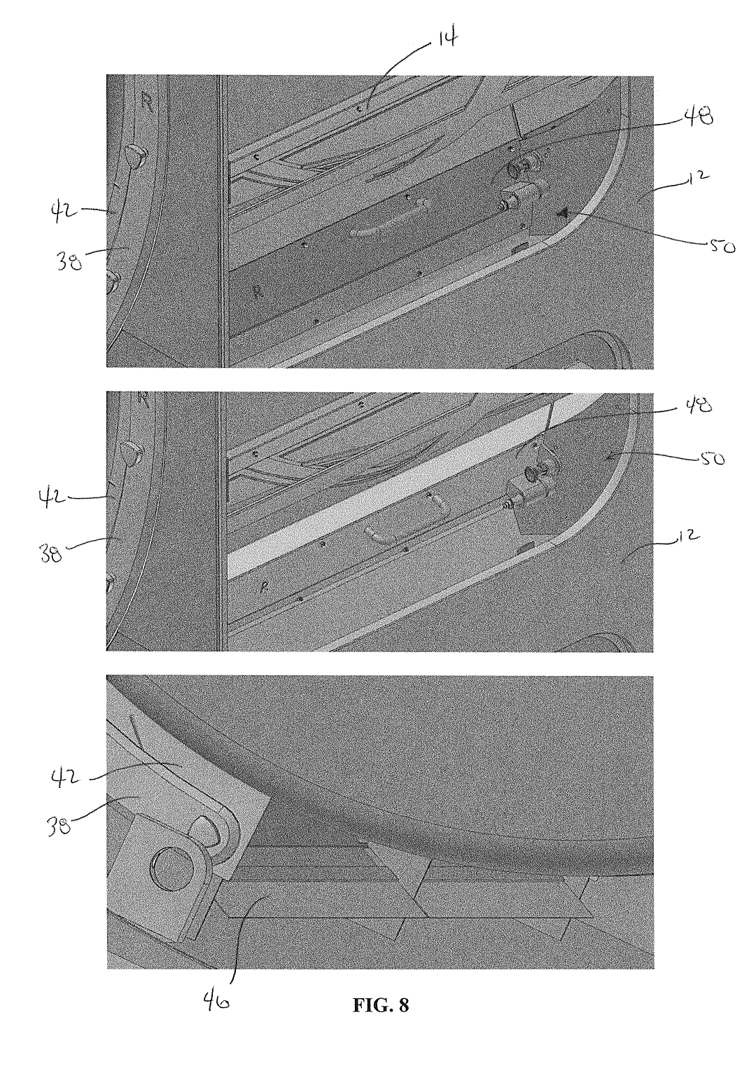

FIGS. 2-8 show a production coater 10 with an integrated exhaust plenum according to one embodiment of this invention. The production coater 10 is a machine for coating pharmaceutical tablets and similar applications, preferably with a solution or a suspension. The production coater 10 is preferably a production scale coater capable of production in the range of approximately 30 liters to approximately 1,200 liters of material per batch. However, the production coater 10 of this invention should not be limited to this range and may be designed to handle any volume.

The production coater 10 of this invention preferably includes a cabinet 12 housing a drum 14 and a motor, not shown, capable of rotating the drum 14. The drum 14 is preferably a production sized coating drum, creating a generally cylindrical or frusto-conical coating vessel. The drum 14 is preferably rotated by the motor to create an internal mixing chamber within the drum 14.

The cabinet 12 provides a sealed, sanitary enclosure for the mixing and coating operation. The production coater 10 of this invention is preferably constructed of stainless steel, such as HASTELLOY™, or another suitable material compatible with compounds and/or coating solutions used in coating operations.

According to a preferred embodiment of this invention, the production coater 10 may include access to an interior of the cabinet 12 through access door 16 and/or process port 18 positioned within access door 16. In such a manner, the front of coater 10 preferably opens to provide full access to the drum 14 for extraction, insertion, inspection, baffles access, cleaning, maintenance and cleaning validation.

FIG. 4 shows the production coater 10 with the cabinet 12 removed to show the drum 12 and an exhaust plenum 20 of this invention. In this embodiment, the exhaust plenum 20 and cabinet 12 form an air flow path 22 from the drum 14 and out of the cabinet 12. In this embodiment, the exhaust plenum 20 includes a pair of side walls 24, a center wall 26, and a top wall 30. At least one of the side walls 24, the center wall 26 and the top wall 30 connect to a portion of an interior surface of the cabinet 12 to form an enclosed air flow path 22 with an inlet and an outlet to allow air and exhaust to expelled from an interior of the drum 14 to outside of the production coater 10. In a preferred embodiment, the interior surface of the cabinet 12 provides a rear wall and/or a bottom wall for the exhaust plenum 20. In alternative embodiment, the exhaust plenum 20 may include additional walls, such as a wall at the bottom or rear of the exhaust plenum, to enclose the exhaust plenum and prevent air or exhaust from leaking into other internal part of the production coater 10.

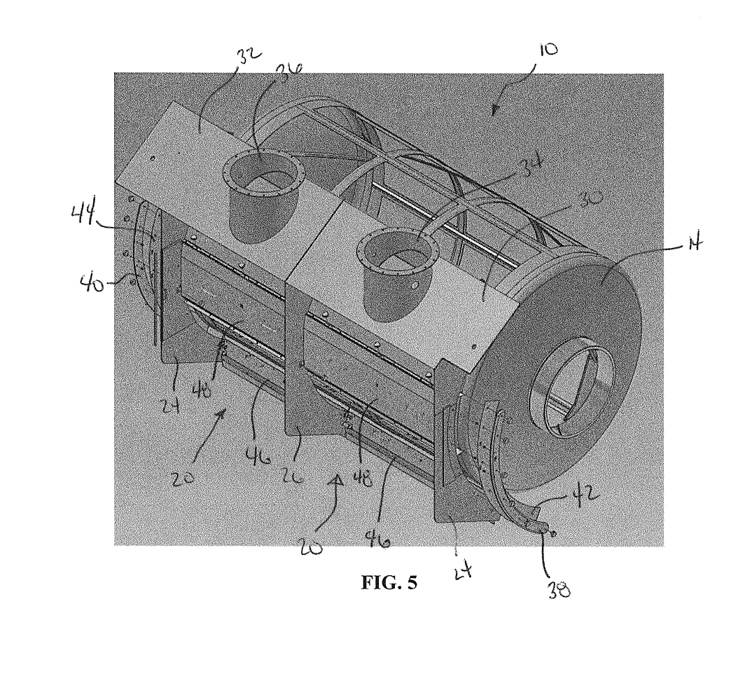

In the embodiment of FIG. 2, the drum comprises a cylinder and frusto-conical shape. Each of the pair of side walls 24 of the exhaust plenum 20 are positioned in proximity to a transition in the drum 14 from the cylinder to the conical shape, extending at approximately at a right angle to the cylinder. The side walls 24 each further include a curved edge that corresponds to surface of the cylinder of the drum and minimize a gap between the curved edge and the drum 14. The center wall 26 is shaped similar to the side walls 24 and positioned near the center of the cylinder. Each of the side walls 24 and the center wall 26 extend from the drum to an interior surface of the cabinet 12, where the side walls 24, center wall 26 and the interior surface of the cabinet 12 define at least a portion of the air flow path 22 and provide an enclosed exhaust path for the drum 14. In this embodiment, the rear wall and bottom wall of the integral exhaust plenum 20 is preferably provided by the interior surface of the cabinet 12. Alternatively, the rear wall or the bottom wall may comprise a separate wall to enclose the rear and the bottom of the integral exhaust plenum 20. In the embodiment of FIG. 5, the exhaust plenum 20 also includes a top wall 30, 32 and a pair of exhaust stacks 34, 36 forming openings in the top wall 30, 32. In the embodiment of FIG. 5, the top wall is angled however, the top wall 30, 32 may not be angled and may be flat or curved. In this embodiment, there are two exhaust stacks 34, 36 however it should be understood that alternative embodiments may include one or more than two exhaust stacks.

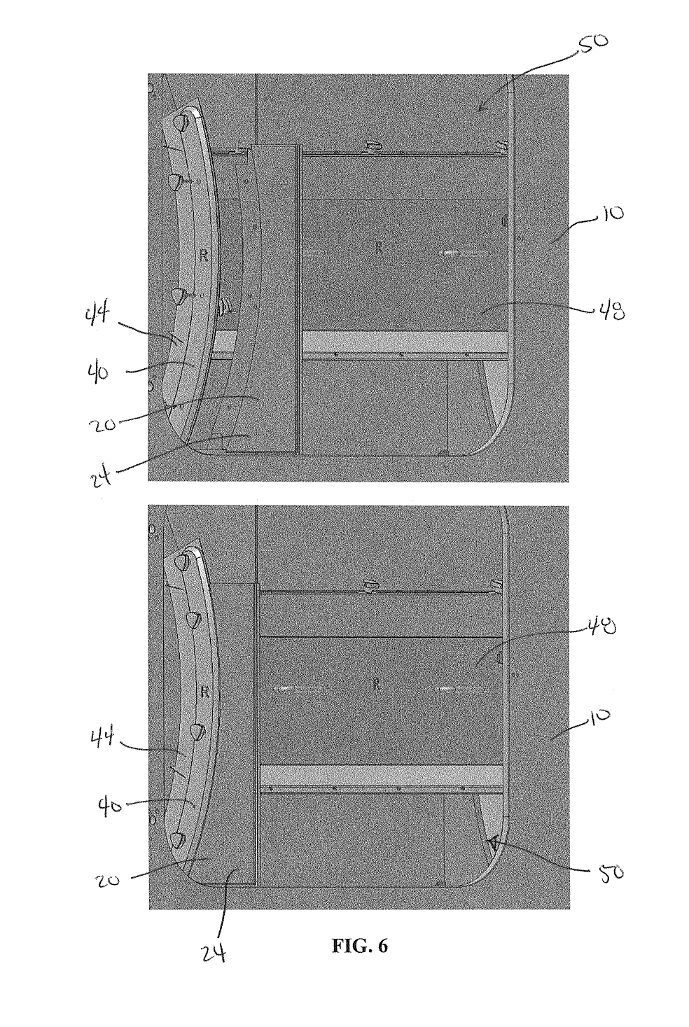

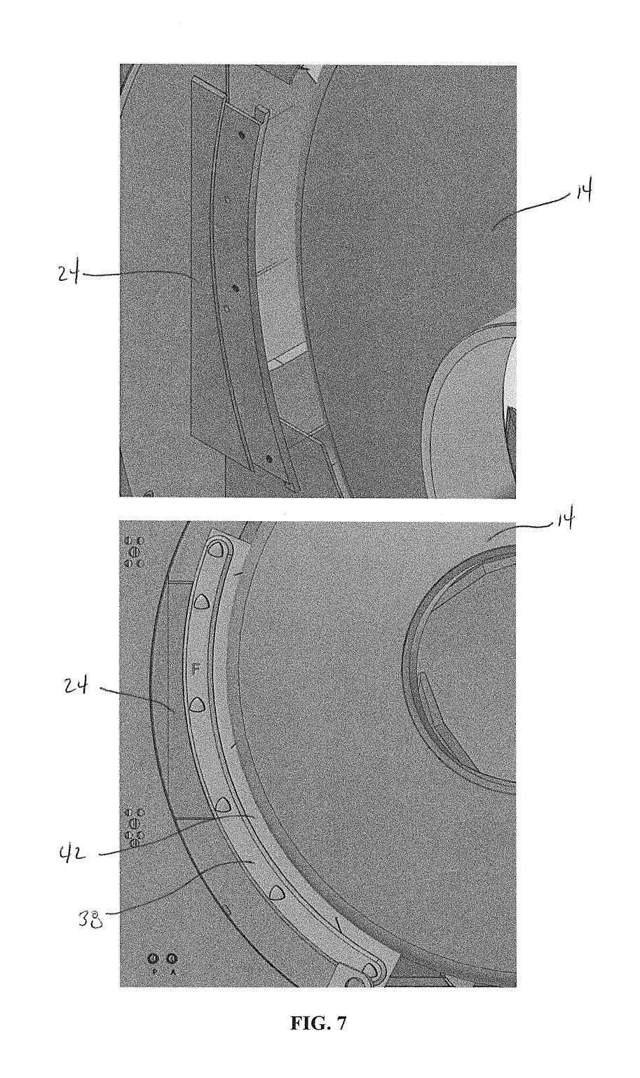

As best shown in FIGS. 5 and 6, the pair of side walls 24, 26 may each further include a rib 38, 40 and a plate 42, 44 to at least partially seal and/or enclose an edge of an inlet to the exhaust plenum 20, when the drum 14 is positioned next to the exhaust plenum 20. In a preferred embodiment, the exhaust plenum 10 may further include one or more upper seals and lower seals 36 positioned between each the pair of side walls 24 and the center wall 26 to further enclose the inlet to the exhaust plenum between the exhaust plenum 20 and the drum 14. In a preferred embodiment, one or more of the seals may be moveable to simplify cleaning, draining or other maintenance of the production coater. For example, as best shown in FIG. 7, the lower seal 36 is a rotating lower seal to ensure proper water drainage during a washing cycle.

As best shown in FIG. 4, the production coater 10 of this invention includes an air flow path 22 that takes air into an interior of the drum 14 via an intake 54 and expels the air and other exhaust out of the drum 14, through the integral exhaust plenum 20 and out of the production coater 10 via an outlet 56. In a preferred embodiment, the drum 14 includes a vented or perforated surface and a plurality of baffles. The vented surface provides a path for air to enter the interior of the drum and path for exhaust to be expelled from the interior of the drum 14 to the exhaust plenum 12 without the cores being able to escape the drum. The baffles mix the cores to ensure proper coverage of the cores with the solution or suspension. The baffles are preferably removable and replaceable or adjustable depending on the desired configuration or application. The baffles assist in the coating process by evenly distributing the coating solution or suspension over the material to be coated. The drums of this invention may further include various levels of polishing, multiple perforation patterns, various perforation sizes and shapes and/or various types of mixing baffles and anti-slide bars. Such multiple configuration enable replaceable drums to match perforation size and shape to various substrates, processes and wash requirements; match perforation pattern to various structural requirements; and permit the processing of tablets, granules, beads, very small tablets and/or other objects. Drums may further include meshed perforations.

As shown in FIGS. 5, 6, and 8, the exhaust plenum 20 includes a reduction baffle 48 to reduce the inlet to the exhaust plenum 20 to prevent air bypass leakage when smaller volumes of tablets (multiple sizes are provided to adjust for varying bed depths). The reduction baffle 48 is preferably operable to allow the drum 14 to be sealed during coating of the cores with solution or suspension and operable to open the air flow path 22 through the exhaust plenum 20 when evacuating the drum 14.

As best shown in FIG. 2, the production coater 10 of this invention preferably further includes an inspection door 50 in the cabinet 12 that allows for access to the interior of the exhaust plenum 20 to facilitate cleaning, either horizontally or vertically, and/or to facilitate inspection of the exhaust plenum 20 and cabinet assembly 12 and/or the drum 14.

The production coater 10 of this invention preferably further includes spray bar 52 extending into a mixing chamber of drum 14. The spray bar 52 is preferably externally adjustable from outside cabinet 12, such as through adjustment device. The spray bar 52 disperses a desired coating solution over the material to be coated and may be positioned in a desirable manner to facilitate a desired coating.

The various components of the production coater 10 are preferably accessible and viewable from the access door 16 and/or the process port 18 positioned within access door 16. The process port 18 is preferably connected within access door 16 and permits direct and/or indirect access to the mixing chamber of drum 14. Each of access door 16 and process port 18 are preferably independently openable for access to a coating chamber within the coater 10, the coating drum 14 and/or the batch of material within and/or other components within the coater 10, such as the spray bar 52.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. A production coater for coating a material with a solution or a suspension, the production coater comprising:
a cabinet;
a coating drum including a perforated sidewall, the coating drum positioned within the cabinet;
a motor to rotate the drum;
an exhaust plenum integrated with the cabinet and adjacent to the drum to form an exhaust path from the coating drum and out of the cabinet, wherein the exhaust plenum includes a side wall, and wherein the side wall and a portion of an internal wall of the cabinet form an at least partially enclosed path from an inlet to an outlet of the exhaust plenum.

2. The production coater of claim 1, further including an access door positioned in the cabinet to permit removal and maintenance of exhaust plenum components.

3. The production coater of claim 1, wherein the side wall conforms to an outer curve of the drum.

4. The production coater of claim 3, wherein the side wall includes a plate to enclose an edge of the drum when the drum is positioned next to the exhaust plenum.

5. The production coater of claim 1, wherein the exhaust plenum includes a seal to enclose an opening between the exhaust plenum and the drum.

6. The production coater of claim 1, wherein the cabinet includes an inspection door, wherein the inspection door provides access to the exhaust path.

7. The production coater of claim 1, wherein the side wall is removeable from the production coater.

8. A production coater for coating a material with a solution or a suspension, the production coater comprising:
a cabinet;
a coating drum positioned within the cabinet and connectable to a motor of the production coater;
an exhaust plenum connected in air-flow communication with the coating drum, the exhaust plenum including a plurality of walls forming an at least partially enclosed path with a portion of the cabinet, the plurality of walls and the portion of the cabinet forming the partially enclosed exhaust path from an opening in the coating drum to an outlet from the cabinet.

9. The production coater of claim 8, wherein the opening in the coating drum comprises perforated sidewall.

10. The production coater of claim 8, wherein the exhaust plenum includes a plate connected to at least one of the plurality of walls to at least partially seal an edge of an inlet of the exhaust plenum adjacent to the coating drum.

11. The production coater of claim 8, wherein the exhaust plenum includes a horizontal seal connected to at least one of the plurality of walls to at least partially seal an edge of an inlet of the exhaust plenum adjacent to the coating drum.

12. The production coater of claim 11, wherein the horizontal seal comprises an upper seal and a lower seal.

13. The production coater of claim 12, wherein at least one of the upper seal and the lower seal is moveable.

14. The production coater of claim 8, wherein the cabinet includes an inspection door, wherein the inspection door provides access to the exhaust path.
